(19) United States
(12) Patent Application Publication
(10) Pub. No.: US 2014/0208965 A1
(43) Pub. Date: Jul. 31, 2014

(54) Methods and Apparatus for Disabling Electronic Media

(71) Applicant: Daniel J. Noblitt, Scottsdale, AZ (US)

(72) Inventor: Daniel J. Noblitt, Scottsdale, AZ (US)

(21) Appl. No.: 14/169,095

(22) Filed: Jan. 30, 2014

Related U.S. Application Data
(60) Provisional application No. 61/758,685, filed on Jan. 30, 2013.

(51) Int. Cl. B30B 9/00

(52) U.S. Cl. CPC B30B 9/00
USPC 100/99

(57) ABSTRACT

Methods and apparatus for disabling electronic media according to various aspects of the present technology may comprise a destroyer within a housing. The electronic medium may be placed in the housing and the destroyer may destroy the electronic media. A verification system permits proper destruction of the electronic medium to be verified.

### CROSS-REFERENCE TO RELATED APPLICATION

This application claims the benefit of U.S. Provisional Patent Application No. 60/758,685, filed Jan. 30, 2013, and incorporates the disclosure of such application by reference.

### BACKGROUND OF THE TECHNOLOGY

Computers and other electronic devices rely on electronic media to store information, and the electronic media come in a variety of different configurations like hard drives, USB drives, CD-ROMs, DVD-ROMs, memory chips, memory cards, and solid state memories. These electronic media are universal and ubiquitous, and are designed to be rugged, sometimes virtually indestructible, in normal use.

The electronic media may, however, become inoperable, outdated, or obsolete. Disposal of these electronic media can be difficult. Some users may overwrite or erase the electronic medium, but these solutions required operable electronic media and particular software and/or equipment. Others may attempt to destroy the electronic media, but this can be difficult and may not be fully effective. Other common disposal methods are to merely store electronic media or to throw them away and hope for the best.

### SUMMARY OF THE TECHNOLOGY

Methods and apparatus for disabling electronic media according to various aspects of the present technology may comprise a destroyer within a housing. The electronic medium may be placed in the housing and the destroyer may destroy the electronic media. A verification system permits proper destruction of the electronic medium to be verified.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates an electronic media disabler according to various aspects of the present technology.

FIG. 2 is a front view of an exemplary electronic media disabler;

FIG. 3 is a cross-section side view of an electronic media disabler;

FIG. 4 is a front view of an electronic media disabler with dual destroyers; and

FIG. 5 is a flow chart of a process for destroying an electronic medium.

Elements and steps in the figures are illustrated for simplicity and clarity and have not necessarily been rendered according to any particular sequence. For example, steps that may be performed concurrently or in different order are illustrated in the figures to help to improve understanding of embodiments of the present technology.

### DETAILED DESCRIPTION OF EXEMPLARY EMBODIMENTS

### Intro

The present technology may be described in terms of functional block components and various processing steps. Such functional blocks may be realized by any number of hardware or software components configured to perform the specified functions and achieve the various results. For example, the present technology may employ various housings, destroyers, verification systems, inputs, and the like, which may carry out a variety of functions. In addition, the present technology may be practiced in conjunction with any number of electronic media, and the system described is merely one exemplary application for the technology. Further, the present technology may employ any number of conventional techniques for destroying objects, verifying destruction, and the like.

### General

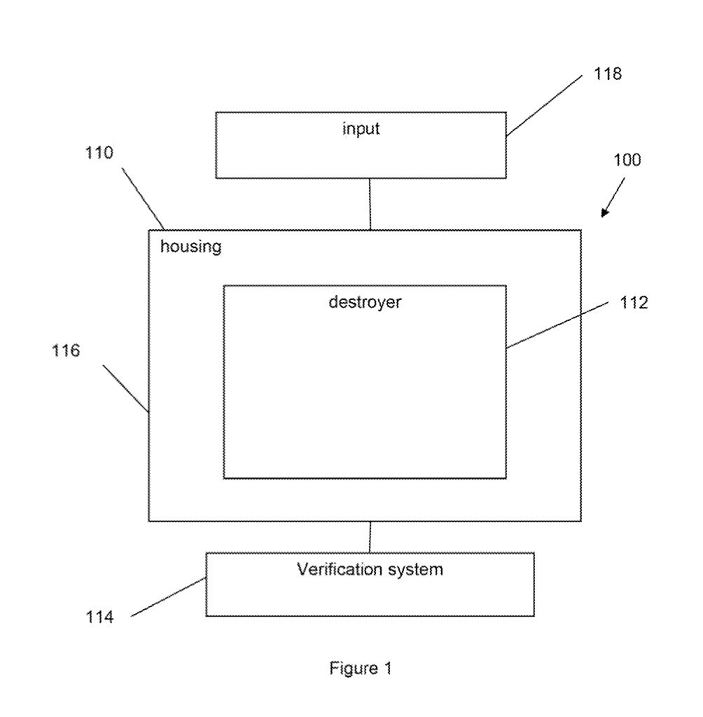

Methods and apparatus for destroying electronic media may operate in conjunction with an electronic media disabler 100. Referring now to FIG. 1, an exemplary electronic media disabler according to various aspects of the present technology may comprise a housing 110, a destroyer 112, and a verification system 114. The housing 110 receives the electronic media to be destroyed, the destroyer 112 destroys the media, and the verification system 114 facilitates verification that the electronic media are destroyed.

### Electronic Media

The electronic media to be destroyed may be any suitable electronic media, such as a hard dive, a USB drive, a solid state memory, a CD-ROM, a DVD-ROM, or other media. In one embodiment, the electronic media disabler 100 destroys hard drives that have been pulled from a computer but are otherwise intact. In another embodiment, the electronic media disabler 100 destroys multiple types of electronic media. For example, a single destroyer 112 may destroy multiple types of electronic media, or multiple destroyers 112 in the electronic media disabler 100 may destroy different types of electronic media.

### Housing

The housing 110 receives the electronic media to be destroyed. The housing 110 may comprise any appropriate structure for receiving the electronic media to be destroyed, such as an enclosure, a partial enclosure, or a shield. The housing 110 may serve several functions, such as to hold or otherwise support the electronic media while it is destroyed, contain the destroyer 112, shield the user from shards and shrapnel from destroyed electronic media, deploy the verification system 114, or support other elements.

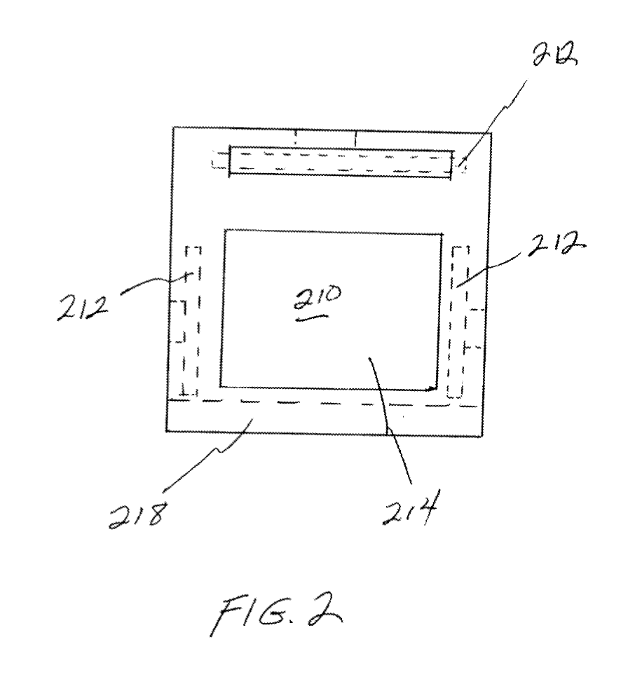

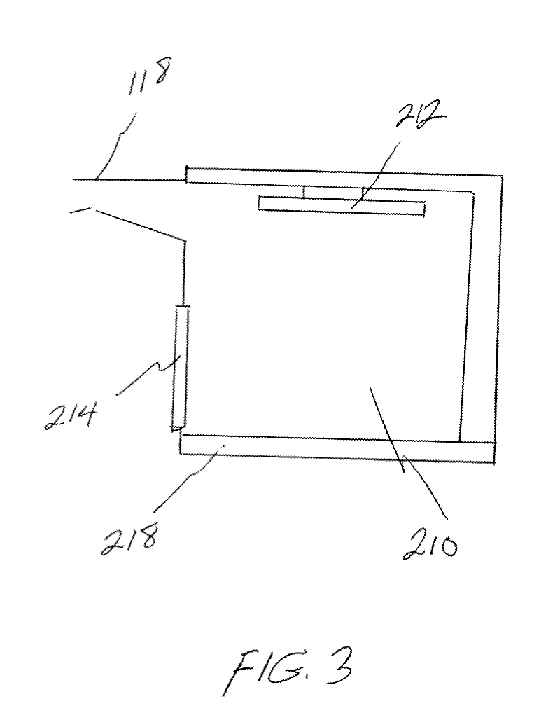

In one embodiment, referring to FIGS. 2 and 3, the housing 110 comprises an enclosure 116, such as a box or barrel shape. The housing 110 may comprise any appropriate material, such as a durable and rigid metal or plastic to contain shards of electronic media during destruction. The housing 110 may have an interior chamber 210 for receiving the electronic media to be destroyed. The interior chamber 210 may include a shelf, platform 218, or other surface on which the electronic media rests prior to and/or during destruction.

### Input

Referring to FIGS. 1-3, an input 118 may facilitate transferring the electronic media to the destroyer 112 for destruction. The input 118 may comprise any suitable system for transferring the electronic media, such as a slot, door, or drawer for transferring the electronic media into the housing 110. The input 118 may lock or otherwise be disabled during the destruction process to inhibit introduction of foreign objects or user interference. In various embodiments, the input 118 is adapted to allow the electronic media to be inserted into the housing 110 but inhibit user access after the electronic medium is inserted such that the input 118 is “one-way;” electronic media can be inserted into the housing 110 via the input 118 but cannot be withdrawn via the input 118.

For example, the input 118 may comprise a slot formed in the top of the housing 110 through which the electronic media may be inserted. The input 118 may also comprise a slot cover that may be secured closed after insertion of the electronic media and then reopened following destruction. Other input mechanisms may comprise a door formed in the housing 110, a mechanism for opening the housing 110 like a clamshell or jewelry box, a secure drawer like those used for bank drive-through windows, a drop chute like those used for standalone street mailboxes, or other suitable access systems.

### Destroyer

The destroyer 112 destroys or otherwise disables the electronic medium. In one embodiment, the destroyer 112 physically destroys or disables the electronic medium. The destroyer 112 may comprise any suitable system for destroying or otherwise disabling the electronic medium, and may be selected according to the particular type of medium to be destroyed. For example, relatively flimsy electronic media such as CD-ROMs and DVD-ROMs may be destroyed by less robust destroyers like a shredder or a grinder. Sturdier electronic media like intact hard drives (as opposed to the comparatively flimsy platters within) may require a different destroyer 112, such as a system for driving a spike through the electronic medium, substantially bending, crumpling, or otherwise mutilating the electronic medium, shattering, cutting, or disassembling the electronic medium into pieces, or incinerating, burning, or melting the electronic medium. A single destroyer 112 may destroy multiple types of media or a single type of medium, and the electronic media disabler 100 may comprise one or multiple destroyers 112.

The destroyer 112 may be selected according to any appropriate criteria, such as effectiveness at destroying the media, cost, safety, or ease of implementation. The destroyer 112 may also be selected according entertainment criteria. For example, users might be entertained by watching the destroyer 112 mash a hard drive into a cube like a car crusher crushes a car, or seeing a USB drive get pulverized by a grinder or shredder, or melted into goo. The destruction process may be not only practical but fun. In various embodiments, the destroyer 112 may comprise a compactor, such as a “pancake” compactor that flattens the medium by a hydraulically powered plate or a baling press compactor 212 that compresses the medium from several directions until it resembles a cube, bale, or block.

The destroyer 112 may be implemented in any appropriate manner to destroy or otherwise disable the electronic medium. In the present embodiment, the destroyer 112 is disposed within the housing 110 and destroys the electronic media after it is received via the input 118. For example, the destroyer 112 may comprise a press adapted to bend the electronic medium in half within the interior chamber 210, or a crusher configured to crush the electronic medium within the interior chamber 210. The destroyer 112 may destroy the electronic medium within the housing 110 to protect the user from injury and ensure proper destruction of the electronic medium.

### Verification System

The verification system 114 facilitates verification of the electronic media destruction. The verification system 114 may comprise any suitable system for verifying that the electronic medium has been securely destroyed to the satisfaction of the user. The verification system 114 permits the user to ensure that the electronic medium has, in fact, been destroyed.

In one embodiment, the verification system 114 may be integrated into or otherwise supported by the housing 110. For example, the verification system 114 may comprise a window 214 defined in the housing 110 or other viewing system to allow the user to watch the destruction process, thus verifying that the electronic medium has been destroyed. Other visual verification systems, such as a camera transmitting images of the destruction in progress to a display that is viewable by the user, may also be utilized. The verification system 114 may also comprise a return mechanism for returning the destroyed medium (or its pieces) to the user. For example, the verification system 114 may comprise a slot defined in the bottom of the housing 110 through which the destroyed electronic medium drops or a drawer from which the destroyed electronic medium may be withdrawn. The user may then dump the destroyed and returned electronic medium on site or at a remote location for extra security, distribute pieces at different locations to inhibit reassembly, destroy the remnants of the electronic medium, or take them away for storage or verification for third parties.

### Multiple Destroyer System

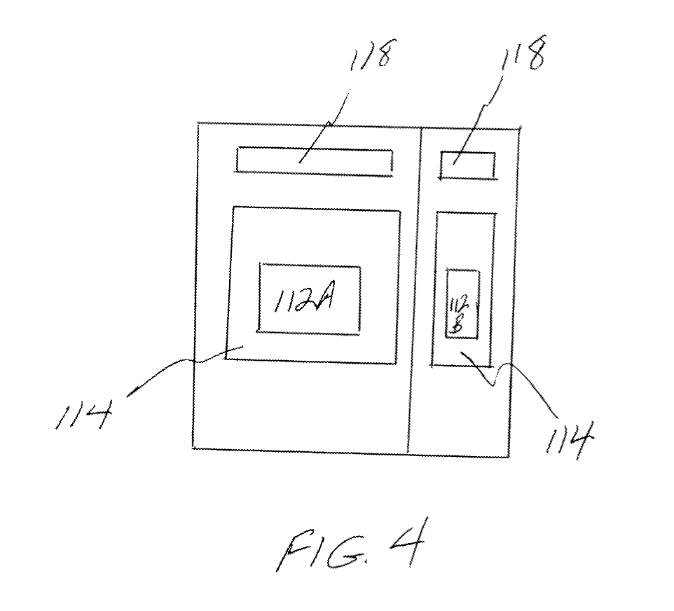

The electronic media disabler 100 may be configured with a single destroyer 112 or multiple destroyers 112. For example, referring to FIG. 4, the electronic media disabler 100 according to various aspects of the present technology may comprise a first destroyer 112A for destroying a first type of electronic media, such as hard drives, and a second destroyer 112B for destroying a second type of electronic media, such as USB drives and CD-ROMs and DVD-ROMs. In one embodiment, the first destroyer 112A comprises a crusher for destroying hard drives and the second destroyer 112B comprises a shredder or grinder for shredding or grinding up USB drives and ROM discs. Each destroyer 112 may have a corresponding input 118 and verification system 114, or the destroyers 112 may share an input 118 or verification system 114.

### Operation

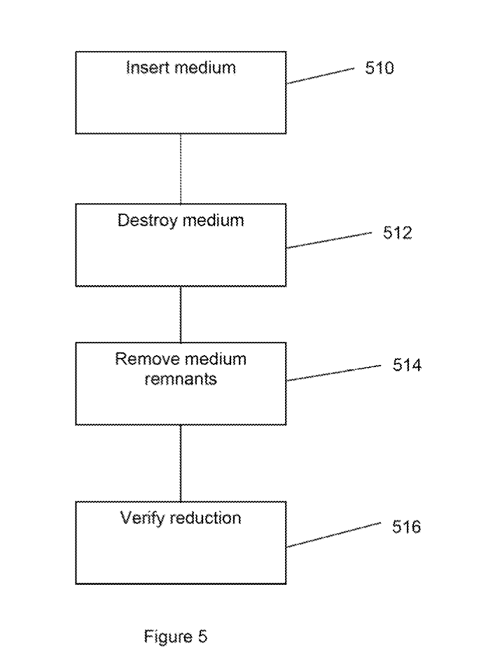

In operation, referring to FIG. 5, a user may insert an electronic medium to be destroyed into the electronic media disabler via the input 118 (510). The electronic medium is retained within the interior chamber 210 of the housing 110. The destroyer 112 destroys or disables the electronic medium (512). The destroyed electronic medium is then evacuated from the interior chamber 210 (514), for example by automatically dumping the remnant into an external receptacle. The verification system 114 permits the user to verify that the electronic medium is destroyed, for example by watching the destruction through a window into the interior chamber 210 or by retrieving the remnants of the destroyed electronic medium (516).

### Closing

In the foregoing specification, the technology has been described with reference to specific exemplary embodiments. Various modifications and changes may be made, however, without departing from the scope of the present technology as set forth in the claims. The specification and figures are illustrative, rather than restrictive, and modifications are intended to be included within the scope of the present technology. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

1. A system for disabling an electronic medium, comprising:
a housing defining an interior chamber;
a destroyer adapted to destroy the electronic medium within the interior chamber; and
a verification system coupled to the housing and adapted to facilitate verification of destruction of the electronic medium.

2. A system according to claim 1, wherein the destroyer comprises a compactor.

3. A system according to claim 1, wherein the destroyer is capable of destroying a hard drive.

4. A system according to claim 1, wherein the destroyer is capable of destroying a USB flash drive.

5. A system according to claim 1, wherein the verification system comprises a window formed in the housing.

6. A system according to claim 1, wherein the verification system comprises a return mechanism.

7. A system according to claim 1, further comprising a one-way input adapted to transfer the electronic medium to the interior chamber.

8. A system according to claim 1, wherein the housing comprises an enclosure.

9. A system according to claim 1, wherein the housing comprises a shield.

10. A system for disabling an electronic medium, comprising:
a housing including an interior chamber capable of holding the electronic medium;
a destroyer having access to the interior chamber and capable of destroying the electronic medium;
a window formed in the housing and facilitating viewing of the electronic medium being disabled by the destroyer in the interior chamber; and
a return mechanism coupled to the interior chamber and configured to transfer a remnant of the electronic medium out of the interior chamber.

11. A system according to claim 10, wherein the destroyer comprises a compactor.

12. A system according to claim 10, wherein the destroyer is capable of destroying a hard drive.

13. A system according to claim 10, wherein the destroyer is capable of destroying a USB flash drive.

14. A system according to claim 10, further comprising a one-way input adapted to transfer the electronic medium into the interior chamber.

15. A system according to claim 10, wherein the housing comprises an enclosure.

16. A system according to claim 10, wherein the housing comprises a shield.

17. A system for disabling an electronic medium, comprising:
a housing, comprising:
an opening configured to receive the electronic medium; and
an interior chamber coupled to the opening configured to receive the electronic medium from the opening and contain the electronic medium;
a destroyer disposed within the housing, wherein the destroyer destroys the electronic medium in the interior chamber; and
a verification system having access to the interior chamber, wherein the verification system provides visual verification of the destruction of the electronic medium.

18. A system according to claim 17, wherein the verification system comprises a window defined in the housing and providing visual access to the interior chamber.

19. A system according to claim 17, wherein the destroyer is configured to destroy a hard drive.

20. A system according to claim 17, wherein the destroyer is configured to destroy a USB flash drive.
